(19) United States
(12) Patent Application Publication
(10) Pub. No.: US 2026/0213843 A1
(43) Pub. Date: Jul. 23, 2026

(54) WIRELESS SYSTEM, TRANSMISSION APPARATUS AND TRANSMISSION METHOD

(71) Applicant: NTT, Inc, Tokyo (JP)

(72) Inventors: Hideki TOSHINAGA, Musashino-shi (JP); Daisei UCHIDA, Musashino-shi (JP); Yasuyoshi YAMAMOTO, Musashino-shi (JP); Yuta TAKAHASHI, Musashino-shi (JP); Yushi SHIRATO, Musashino-shi (JP); Takuto ARAI, Musashino-shi (JP); Naoki KITA, Musashino-shi (JP)

(73) Assignee: NTT, Inc., Tokyo (JP)

(21) Appl. No.: 19/139,981

(22) PCT Filed: Dec. 22, 2022
(86) PCT No.: PCT/JP2022/047363

§ 371 Date: Jun. 17, 2025

(51) Int. Cl. H04B 10/2575; H04B 7/024

(52) U.S. Cl. CPC H04B 10/25753; H04B 7/024

(57) ABSTRACT

A wireless system includes a plurality of distributedly arranged antennas and a wireless base station. The plurality of antennas and the wireless base station are connected using radio-over-fiber (RoF). The plurality of antennas are divided into a plurality of groups, and the wireless system transmits or receives radio wave by the antennas at different timings for each group.

### TECHNICAL FIELD

The present invention relates to a wireless system, a transmission apparatus and a transmission method.

### BACKGROUND ART

In order to realize an ultra-high speed and large capacity wireless system for the sixth generation mobile communication system (6G), development with a large number of distributed antennas has been studied (see, for example, Non Patent Literature 1). In order to efficiently deploy these distributed antennas, utilization of analog radio-over-fiber (A-RoF) has been studied (see, for example, Non Patent Literature 2).

### CITATION LIST

### Non Patent Literature

Non Patent Literature 1: DOCOMO 6G White Paper, Version 5.0, “5G Advancements and 6G”, DOCOMO, Inc., November 2022, [online], Internet <https://www.docomo.ne.jp/corporate/technology/whitepaper_6g/>

Non Patent Literature 2: Kouta Ito, Mizuki Suga, Yushi Shirato, Naoki Kita, and Takeshi Onizawa, “Efficiently accommodating various high-frequency-band wireless systems by using analog RoF”, NTT Journal, NIPPON TELEGRAPH AND TELEPHONE CORPORATION, March 2020, [online], Internet <https://journal.ntt.co.jp/wp-content/uploads/2020/05/JN20200315.pdf>

### SUMMARY OF INVENTION

### Technical Problem

In the A-RoF technology, a wireless electrical signal received by an RoF slave unit is converted into an optical signal and placed on a wavelength (transmission channel) of light, and the optical signal is returned to the electrical signal by an RoF master unit and sent to a wireless base station. The wireless base station performs demodulation processing on the wireless electrical signal received from the RoF master unit.

In such a wireless system configuration, in a case where a wavelength (transmission channel) of light is allocated to each ROF slave unit, an optical wavelength of at least the same number as the number of RoF slave units connected to the RoF master unit is required. In addition, in a case where an optical wavelength is utilized for signal control or the like, since a plurality of optical wavelengths is allocated to the RoF slave units, the required number of wavelengths is the number of ROF slave units×the number of wavelengths used for signal control.

Furthermore, in a case where the wireless base station simultaneously receives the electrical signals transmitted from all the distributedly arranged antennas, noise generated in all the RoF slave units, the optical fiber section, and the RoF master unit is synthesized and becomes an input to the wireless base station. As a result, since the noise received by the wireless base station increases according to the number of connections of the ROF slave devices, deterioration of the signal-to-noise power ratio is assumed.

In view of the above circumstances, an object of the present invention is to provide a wireless system, a transmission apparatus and a transmission method capable of performing high-quality communication using a distributed antenna while reducing the number of optical wavelengths to be used.

### Solution to Problem

An aspect of the present invention is a wireless system which connects a plurality of distributedly arranged antennas and a wireless base station using radio-over-fiber (RoF), in which the plurality of antennas are divided into a plurality of groups, and a radio wave is transmitted or received by the antenna at different timings for each of the groups.

An aspect of the present invention is a transmission apparatus including a plurality of conversion units, which are provided corresponding to the plurality of distributedly arranged antennas, that perform one or both of processing of converting an optical signal representing a signal having been received by the corresponding antenna by a radio wave into an electrical signal and processing of converting a signal to be transmitted from the corresponding antenna by a radio wave from the electrical signal into an optical signal, and a switch unit, when the plurality of antennas are divided into a plurality of groups, that performs one or both of processing of outputting, to a wireless base station, the electrical signal having been converted by the conversion unit corresponding to the antenna belonging to the group at different timings for each of the groups, and processing of receiving, from the wireless base station, the signal to be transmitted from the antenna and outputting the received signal to the conversion unit corresponding to the antenna belonging to the group.

An aspect of the present invention is a transmission method executed by a wireless system in which a plurality of distributedly arranged antennas and a wireless base station are connected using radio-over-fiber (RoF), in which the plurality of antennas are divided into a plurality of groups, the method including a step of causing the wireless system to transmit and receive a radio wave by the antenna at different timings for each of the groups.

### Advantageous Effects of Invention

According to the present invention, it is possible to perform high-quality communication using a distributed antenna while reducing the number of optical wavelengths to be used.

### BRIEF DESCRIPTION OF DRAWINGS

FIG. 1 A configuration diagram of a wireless system according to an embodiment of the present invention.

FIG. 2 A diagram illustrating an antenna group in the wireless system according to the embodiment.

FIG. 3 A diagram illustrating an antenna group in the wireless system according to the embodiment.

FIG. 4 A diagram illustrating a configuration related to uplink communication of the wireless system according to the embodiment.

FIG. 5 A diagram illustrating an example of switch switching in a RoF master unit according to the embodiment.

FIG. 6 A diagram illustrating a configuration related to downlink communication of the wireless system according to the embodiment.

FIG. 7 A diagram illustrating an example of switch switching in the RoF master unit according to the embodiment.

FIG. 8 A diagram illustrating a configuration related to switch switching control of the RoF master unit according to the embodiment.

FIG. 9 A diagram illustrating an example of switch switching control of the RoF master unit according to the embodiment.

FIG. 10 A diagram illustrating a hardware configuration of the RoF master unit according to the embodiment.

### DESCRIPTION OF EMBODIMENTS

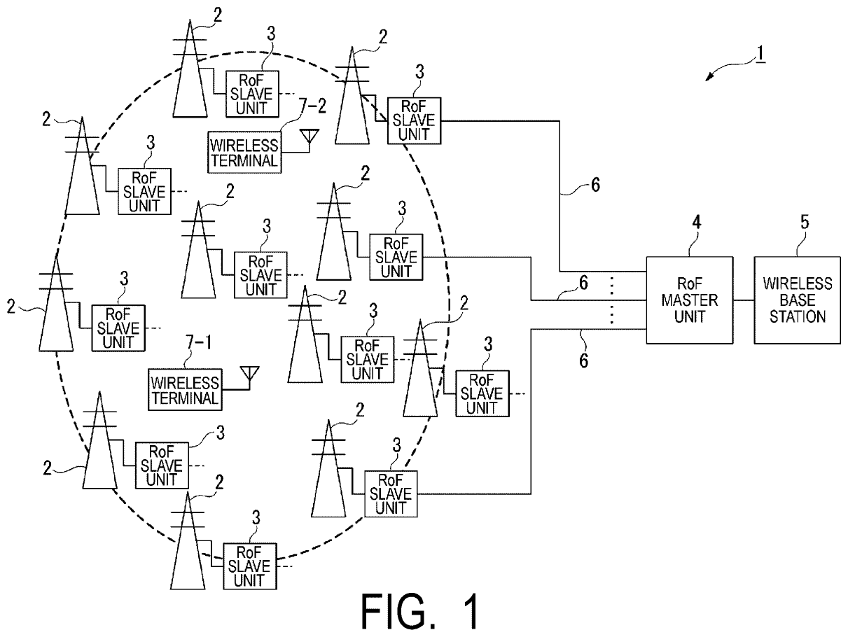

Hereinafter, an embodiment of the present invention will be described in detail with reference to the drawings. FIG. 1 is a diagram illustrating a configuration example of a wireless system 1. The wireless system 1 includes an antenna 2, an RoF slave unit 3, an RoF master unit 4, and a wireless base station 5. As illustrated in FIG. 1, the wireless system 1 includes a plurality of distributedly arranged antennas 2. The wireless base station 5 and the plurality of distributedly arranged antennas 2 are RoF connected. The RoF slave unit 3 is connected to each antenna 2. The plurality of RoF slave units 3 and the RoF master unit 4 are connected via an optical fiber 6. In addition, the wireless system 1 communicates with one or more wireless terminals 7. The two wireless terminals 7 illustrated in FIG. 1 are referred to as a wireless terminal 7-1 and a wireless terminal 7-2, respectively. In addition, a direction from the wireless terminal 7 to the wireless base station 5 is referred to as “uplink”, and a direction from the wireless base station 5 to the wireless terminal 7 is referred to as “downlink”.

The RoF master unit 4 of the present embodiment is an example of a transmission apparatus. The RoF master unit 4 is provided with an electrical switch that switches an uplink electrical signal to be transmitted to the wireless base station 5, and switches the electrical switch according to the allocation of the antenna 2. As a result, it is possible to repeatedly use the optical wavelength, and the degradation of the signal-to-noise power ratio is suppressed by limiting the number of antennas 2 for transmitting signals simultaneously received by the wireless base station 5.

The antenna 2 transmits and receives wireless signals to and from the wireless terminal 7 by radio waves. The RoF slave unit 3 converts an uplink wireless signal (electrical signal) received by the antenna 2 into an optical signal, outputs the converted optical signal to the optical fiber 6, and transmits the optical signal to the RoF master unit 4. The uplink optical signal indicates waveform information of the uplink wireless signal.

Further, the RoF slave unit 3 receives a downlink optical signal output from the RoF master unit 4 and transmitted through the optical fiber 6. The downlink optical signal indicates waveform information of the downlink wireless signal. The ROF slave unit 3 converts the received downlink optical signal into a wireless signal, and transmits the converted wireless signal from the antenna 2 to the wireless terminal 7 by radio waves.

The RoF master unit 4 receives an uplink optical signal transmitted through the optical fiber 6, and returns the received optical signal to an electrical signal. The RoF master unit 4 outputs the signal returned to the electrical signal to the wireless base station 5. Further, the RoF master unit 4 receives an electrical signal indicating waveform information of a downlink signal from the wireless base station 5. The ROF master unit 4 converts the received downlink electrical signal into an optical signal, outputs the converted optical signal to the optical fiber 6, and transmits the optical signal to the RoF slave unit 3. The wireless base station 5 demodulates the uplink electrical signal received from the RoF master unit 4. In addition, the wireless base station 5 outputs a downlink electrical signal indicating waveform information of a signal generated by modulating data addressed to the wireless terminal 7 to the RoF master unit 4.

In the present embodiment, the wireless system 1 uses a high frequency band such as a quasi-millimeter wave, a millimeter wave, and a terahertz wave for wireless communication between the antenna 2 and the wireless terminal 7. Such a radio wave in a high frequency band has high straightness, and the radio wave does not go around in a case where a shielding object is present. For this reason, in a case where a wireless system is configured using a high frequency band, it is ideal that there is no shielding object between the antenna on the wireless base station side and the antenna on the wireless terminal side, and that there is a line of sight. Therefore, in the wireless system 1 of the present embodiment, unlike a wireless system using a low frequency band in which a wireless cell is configured and antennas are arranged at the center of the wireless cell or at an area end of the wireless cell, a plurality of antennas 2 are distributedly arranged in one wireless area, and communication is performed with the wireless terminal 7 by using the antenna 2 that can be seen.

The antenna 2 used for each wireless area is determined in advance. Hereinafter, a case where the wireless system 1 has M (M is an integer of 2 or more) wireless areas will be described as an example. A group including a plurality of antennas 2 used for an m-th (m is an integer of 1 or more and M or less) wireless area is referred to as an antenna group #m. In addition, N (N is an integer of 1 or more) antennas 2 included in the antenna group #m are referred to as antennas 2-m-1 to 2-m-N, and the RoF slave unit 3 connected to the antennas 2-m-n (n is an integer of 1 or more and N or less) is referred to as an RoF slave unit 3-m-n. Hereinafter, a case of N=3 will be described as an example.

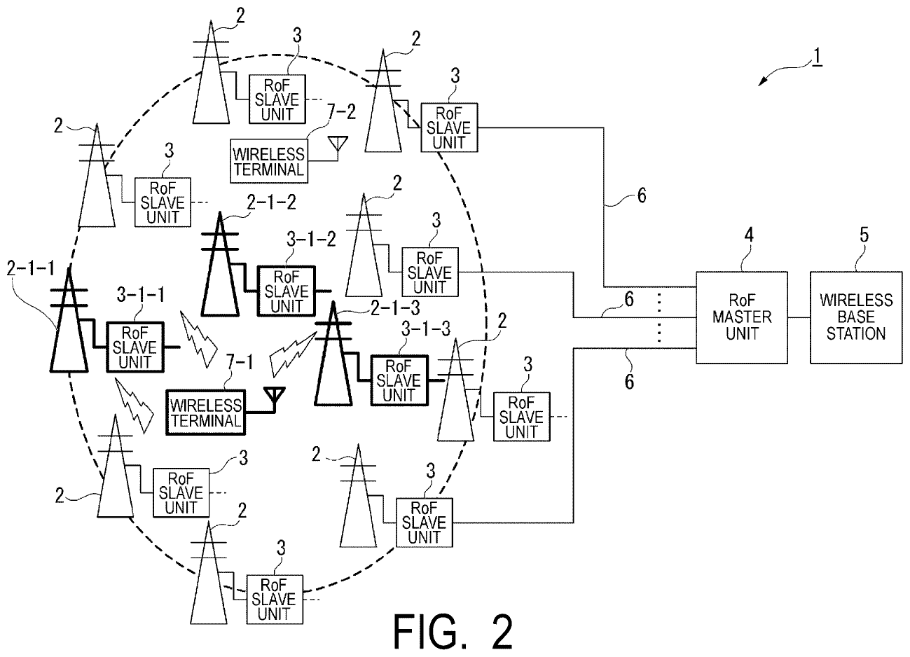

FIG. 2 is a diagram illustrating an antenna group in a case where the wireless terminal 7-1 performs wireless communication in the wireless system 1 illustrated in FIG. 1. In a case where the wireless terminal 7-1 transmits, the antennas 2-1-1 to 2-1-3 belonging to the antenna group #1 receive the wireless signal from the wireless terminal 7-1. The antenna group #1 corresponds to a wireless area where the wireless terminal 7-1 exists. The antennas 2-1-1 to 2-1-3 can perform line-of-sight communication with the wireless terminal 7-1.

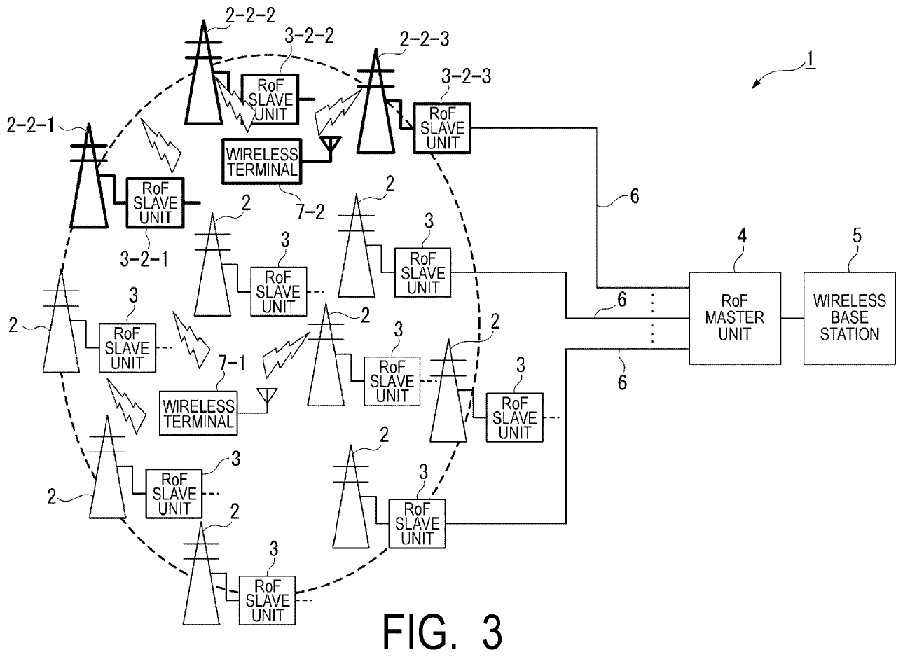

FIG. 3 is a diagram illustrating an antenna group in a case where the wireless terminal 7-2 performs wireless communication in the wireless system 1 illustrated in FIG. 1. In a case where the wireless terminal 7-2 transmits, the antennas 2-2-1 to 2-2-3 belonging to the antenna group #2 receive the wireless signal from the wireless terminal 7-2. The antenna group #2 corresponds to a wireless area where the wireless terminal 7-2 exists. The antennas 2-2-1 to 2-2-3 can perform line-of-sight communication with the wireless terminal 7-2.

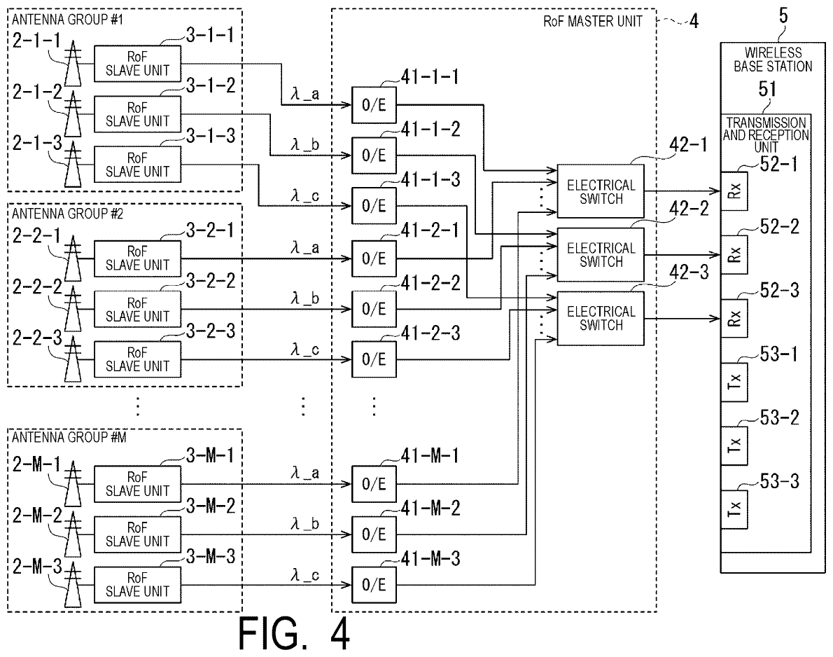

FIG. 4 is a diagram illustrating a configuration example related to uplink communication of the wireless system 1. The RoF master unit 4 includes a plurality of opto-electronic conversion units (O/E) 41 and N electrical switches 42. The opto-electronic conversion units 41 are connected to different the ROF slave units 3 via the optical fibers 6. The opto-electronic conversion unit 41 connected to the n-th RoF slave unit 3-m-n of the antenna group #m will be referred to as the opto-electronic conversion unit 41-m-n. In addition, the N electrical switches 42 are referred to as electrical switches 42-1 to 42-N, respectively. The n-th electrical switch 42-n is connected to the n-th opto-electronic conversion units 41-1-n, 41-2-n, . . . , and 41-M-n of each antenna group.

The opto-electronic conversion unit 41-m-n receives the optical signal transmitted by the RoF slave unit 3-m-n and transmitted through the optical fiber 6. The opto-electronic conversion unit 41-m-n converts the received optical signal into an electrical signal and outputs the electrical signal to the electrical switch 42-n. The electrical switch 42-n receives an uplink electrical signal from the opto-electronic conversion units 41-1-n, 41-2-n, . . . , and 41-M-n. The electrical switch 42-n selects an electrical signal received from the opto-electronic conversion unit 41-m-n and outputs the electrical signal to the wireless base station 5 at a timing when the wireless terminal 7 existing in the wireless area corresponding to the antenna group #m transmits an uplink signal.

The wireless base station 5 includes a transmission and reception unit 51 that transmits and receives signals to and from the RoF master unit 4. The transmission and reception unit 51 includes N reception units (Rx) 52 and N transmission units (Tx) 53. Each of the N reception units 52 is referred to as the reception units 52-1 to 52-N, and each of the N transmission units 53 is referred to as transmission units 53-1 to 53-N. The reception unit 52-n receives the electrical signal output from electrical switch 42-n of the RoF master unit 4. The transmission units 53-1 to 53-N outputs a downlink electrical signal addressed to the wireless terminal 7 to the RoF master unit 4.

Different optical wavelengths for uplink communication are allocated to the plurality of RoF slave units 3 included in the same antenna group. In addition, the same optical wavelength for uplink communication is used in different antenna groups. In the present embodiment, an optical wavelength λ_a is allocated to the RoF slave unit 3-m-1 of the antenna group #m, an optical wavelength λ_b is allocated to the RoF slave unit 3-m-2, and an optical wavelength λ_c is allocated to the RoF slave unit 3-m-3. As a result, light of the same wavelength is repeatedly used for each antenna group. The opto-electronic conversion unit 41-m-n of the RoF master unit 4 returns the optical signal received from the RoF slave unit 3-m-n to an electrical signal and outputs the electrical signal to the electrical switch 42-n. An uplink electrical signal is transmitted from the electrical switches 42-1 to 42-3 to the wireless base station 5 for each antenna group. In the present embodiment, since the antenna group is configured for every three antennas 2, the wireless base station 5 has three reception units 52.

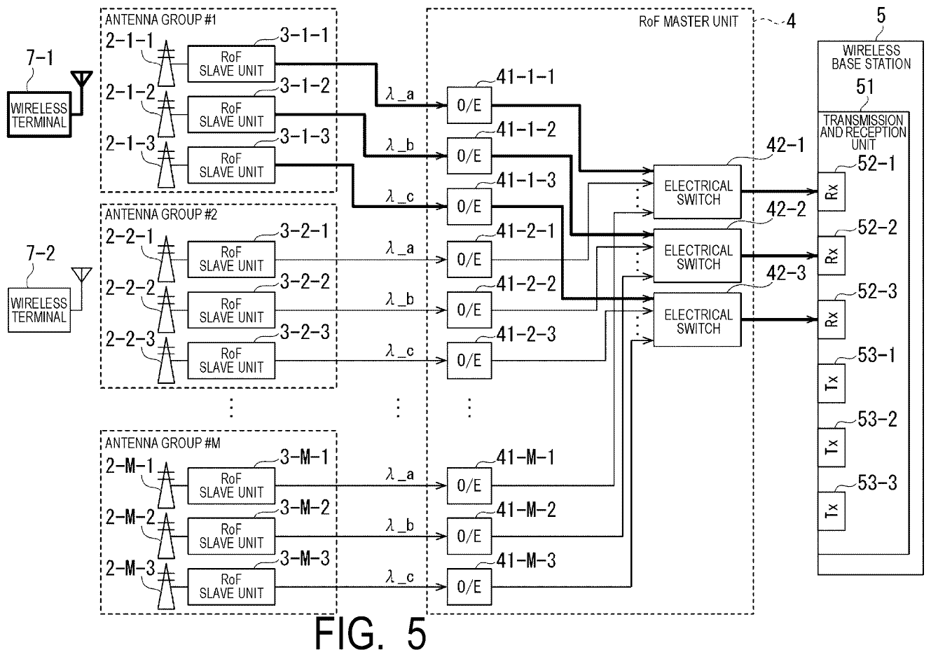

FIG. 5 is a diagram illustrating an example of switch switching in the RoF master unit 4 when the wireless terminal 7-1 performs uplink communication. Each of the RoF slave units 3-1-1 to 3-1-3 receives a wireless signal from the wireless terminal 7-1 via the antennas 2-1-1 to 2-1-3, converts the received wireless signal into an optical signal, and transmits the optical signal to the RoF master unit 4. Each of opto-electronic conversion units 41-1-1 to 41-1-3 of ROF master unit 4 converts the received optical signal into an electrical signal and outputs the electrical signal to electrical switches 42-1 to 42-3. The electrical switches 42-1 to 42-3 perform switching to output the electrical signals received from the opto-electronic conversion units 41-1-1 to 41-1-3 to the reception units 52-1 to 52-3 of the wireless base station 5, respectively.

Since the electrical switch 42 of the RoF master unit 4 performs switching, the electrical signal of the antenna group #1 and the electrical signals of the other antenna groups are not simultaneously input to the reception unit 52 of the wireless base station 5. The same applies to the case of using the antenna group #2 or the case of using other antenna groups. That is, by switching the electrical switch 42 for each antenna group, the uplink electrical signals of different antenna groups are not simultaneously input to the reception unit 52 of the wireless base station 5.

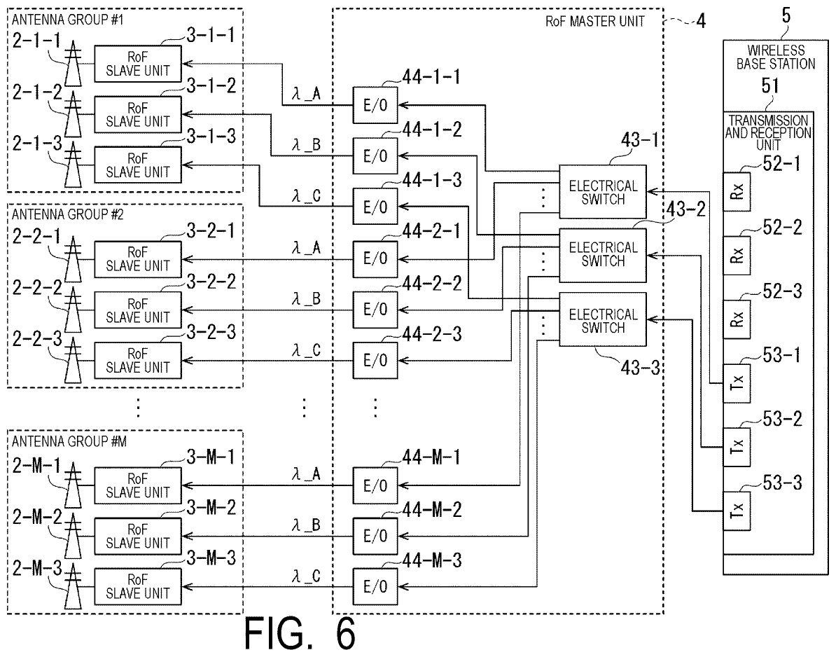

FIG. 6 is a diagram illustrating a configuration example of the wireless system 1 related to the downlink communication. The RoF master unit 4 includes N electrical switches 43 and a plurality of electro-optical conversion units (E/O) 44. The N electrical switches 43 are referred to as electrical switches 43-1 to 43-N, respectively. The electrical-optical conversion units 44 are connected to different RoF slave units 3 by the optical fibers 6. The electrical-optical conversion unit 44 connected to the n-th RoF slave unit 3-m-n of the antenna group #m will be referred to as an electrical-optical conversion unit 44-m-n. The n-th electrical switch 43-n is connected to the transmission unit 53-n of the wireless base station 5 and the n-th electrical-optical conversion units 44-1-n, 44-2-n, . . . , and 44-M-n of each antenna group.

The electrical switch 43-n receives a downlink electrical signal addressed to the wireless terminal 7 from the transmission unit 53-n of the wireless base station 5. The electrical switch 43-n outputs the electrical signal received from the transmission unit 53-n to the electrical-optical conversion unit 44-m-n of the antenna group #m corresponding to the wireless area to which the wireless terminal 7 belongs at the timing of transmitting the downlink signal to the wireless terminal 7. The electrical-optical conversion unit 44-m-n converts an electrical signal received from the electrical switch 43-n into an optical signal and outputs the optical signal to the optical fiber 6.

Different optical wavelengths for downlink communication are allocated to the plurality of ROF slave units 3 included in the same antenna group. In addition, the same optical wavelength for downlink communication is used in different antenna groups. In the present embodiment, an optical wavelength λ_A is allocated to the RoF slave unit 3-m-1 of the antenna group #m, an optical wavelength λ_B is allocated to the RoF slave unit 3-m-2, and an optical wavelength λ_C is allocated to the RoF slave unit 3-m-3. As a result, light of the same wavelength is repeatedly used for each antenna group. In the present embodiment, since the antenna group is configured for every three antennas 2, the wireless base station 5 has three transmission units 53.

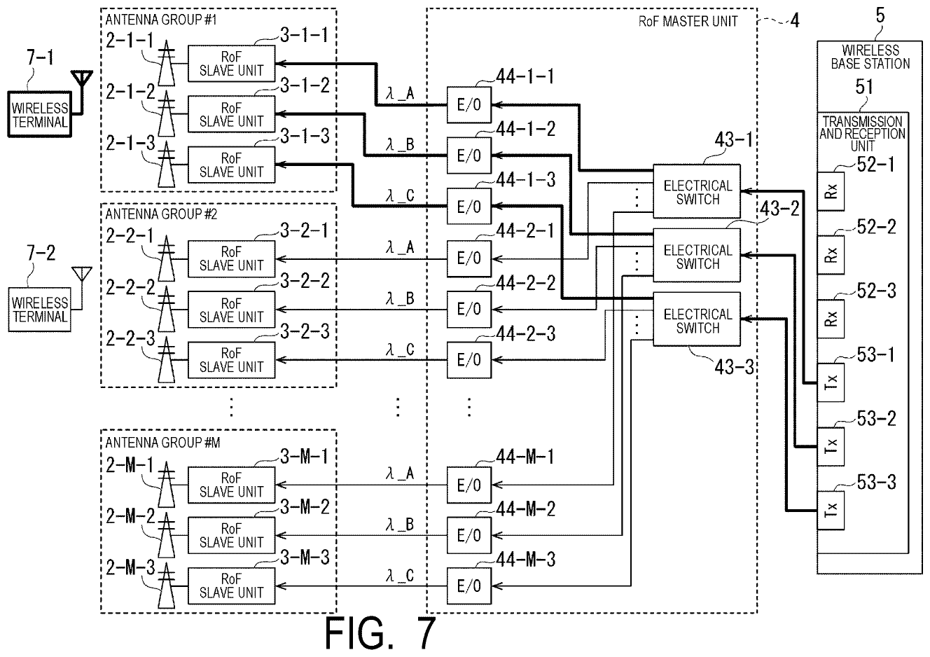

FIG. 7 is a diagram illustrating an example of switch switching in the RoF master unit 4 when the wireless terminal 7-1 performs downlink communication. Each of the transmission units 53-1 to 53-3 of the wireless base station 5 outputs a downlink electrical signal addressed to the wireless terminal 7-1 to the electrical switches 43-1 to 43-3 of the RoF master unit 4. Each of the electrical switches 43-1 to 43-3 outputs the electrical signal received from the transmission units 53-1 to 53-3 of the wireless base station 5 to the electrical-optical conversion unit 44-1-1 to 44-1-3 at the timing of transmitting the downlink signal to the wireless terminal 7-1. Each of the electrical-optical conversion units 44-1-1 to 44-1'converts an electrical signal received from the electrical switches 43-1 to 43-3 into an optical signal and outputs the optical signal to the optical fiber 6. The RoF slave units 3-1-1 to 3-1-3 receive optical signals transmitted from the electrical-optical conversion units 44-1-1 to 44-1-3 of the RoF master unit 4 and transmitted through the optical fiber 6, respectively. The RoF slave units 3-1-1 to 3-1-3 convert the received optical signal into a wireless signal and transmit the wireless signal from the antennas 2-1-1 to 2-1-3. The wireless terminal 7-1 receives and demodulates the wireless signal transmitted from the antennas 2-1-1 to 2-1-3.

Since the electrical switch 43 of the RoF master unit 4 performs switching, the electrical signal of the antenna group #1 and the electrical signals of the other antenna groups are not simultaneously transmitted to the ROF slave unit 3. The same applies to the case of using the antenna group #2 or the case of using other antenna groups. That is, by switching the electrical switch 43 for each antenna group, downlink optical signals of different antenna groups are not output from the RoF master unit 4.

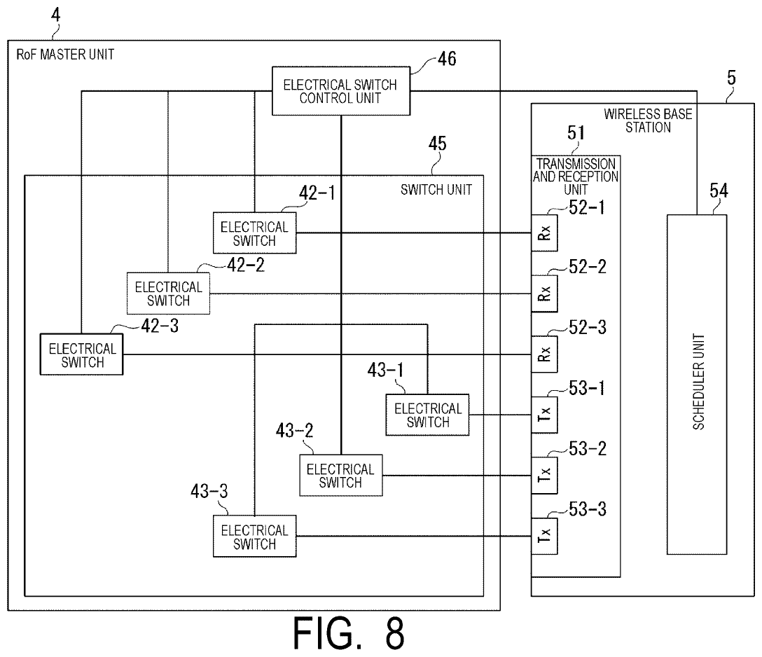

FIG. 8 illustrates a configuration example related to switch switching control of the RoF master unit 4. In FIG. 8, the illustration of the antenna 2, the RoF slave unit 3, the opto-electronic conversion unit 41, and the electrical-optical conversion unit 44 illustrated in FIGS. 4 to 7 is omitted, but they exist similarly, and a part thereof is extracted and illustrated.

The RoF master unit 4 includes a switch unit 45 and an electrical switch control unit 46. The switch unit 45 includes electrical switches 42-1 to 42-N and electrical switches 43-1 to 43-N. The electrical switch control unit 46 uses the schedule information received from the wireless base station 5 to control switching of the electrical switches 42-1 to 42-N and the electrical switches 43-1 to 43-N. The schedule information indicates reception frame timing and transmission frame timing of each antenna group. Note that the electrical switch control unit 46 may be provided in another apparatus connected to the RoF master unit 4.

The wireless base station 5 includes a scheduler unit 54. The scheduler unit 54 assigns reception frame timings and transmission frame timings to each antenna group, and notifies the electrical switch control unit 46 of the RoF master unit 4 of schedule information indicating the assigned timings. The scheduler unit 54 may be provided in another apparatus connected to the wireless base station 5.

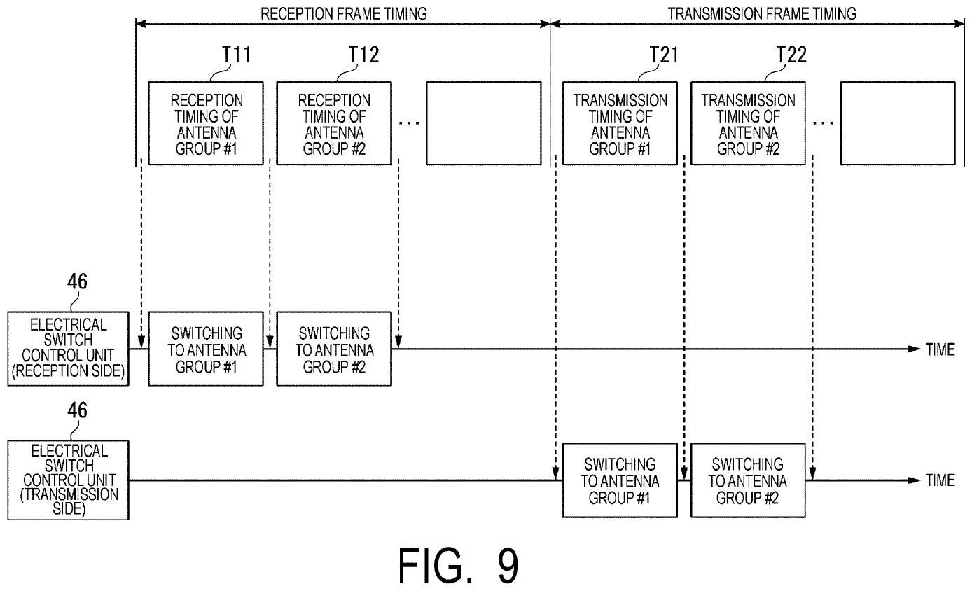

FIG. 9 is a diagram illustrating an example of switch switching control by the electrical switch control unit 46 of the RoF master unit 4. The schedule information includes information on the reception timing of each antenna group at the reception frame timing and the transmission timing of each antenna group at the transmission frame timing. The reception timing is represented by timings of start and end of reception of the uplink signal frame. The transmission timing is represented by timings of start and end of transmission of the downlink signal frame. The electrical switch control unit 46 switches the output of the electrical switches 42-1 to 42-3 to output the electrical signal received from the opto-electronic conversion units 41-m-1 to 41-m-3 at the reception timing of the antenna group #m. In addition, the electrical switch control unit 46 switches the output of the electrical switches 43-1 to 43-3 to output the downlink electrical signal received from the wireless base station 5 to the electrical-optical conversion units 44-m-1 to 44-m-3 at the transmission timing of the antenna group #m.

Specifically, the electrical switch control unit 46 switches the outputs of the electrical switches 42-1 to 42-3 to output the electrical signals received from the opto-electronic conversion units 41-1-1 to 41-1-3 at a reception timing T11 of the antenna group #1. The electrical switch control unit 46 switches the outputs of the electrical switches 42-1 to 42-3 to output the electrical signals received from the opto-electronic conversion units 41-2-1 to 41-2-3 at a reception timing T12 of the antenna group #2.

On the other hand, the electrical switch control unit 46 switches the output of the electrical switches 43-1 to 43-3 to output the downlink electrical signal received from the wireless base station 5 to the electrical-optical conversion units 44-1-1 to 44-1-3 at the transmission timing T21 of the antenna group #1. The electrical switch control unit 46 switches the output of the electrical switches 43-1 to 43-3 to output the downlink electrical signal received from the wireless base station 5 to the electrical-optical conversion units 44-2-1 to 44-2-3 at the transmission timing T22 of the antenna group #2.

In a case where the wavelength of the wireless signal between the antenna 2 and the wireless terminal 7 used for the uplink communication and the optical wavelength between the ROF slave unit 3 and the ROF master unit 4 are different from the wavelength of the wireless signal between the antenna 2 and the wireless terminal 7 used for the downlink communication and the optical wavelength between the RoF slave unit 3 and the RoF master unit 4, the uplink communication processing and the downlink communication processing of the same antenna group in the wireless system 1 may be performed in parallel. In addition, the wireless system 1 may perform only uplink communication or only downlink communication. Furthermore, in the above description, each antenna group uses the same optical wavelength, but an antenna group in which all or some of wavelengths to be used are different may be included.

In addition, in the above description, the case where N antennas 2 belong to each antenna group has been described. However, there may be an antenna group to which N′ (N′ is an integer of 1 or more and N−1 or less) antennas 2 belong. At the reception timing of the antenna group #m to which the N′ antennas 2 belong, each of the N′ electrical switches 42 outputs the uplink electrical signal received from the opto-electronic conversion unit 41 corresponding to each antenna 2 of the antenna group #m to the wireless base station 5. Further, at the transmission timing of the antenna group #m, each of the N′ electrical switches 43 outputs a downlink electrical signal to the electrical-optical conversion unit 44 corresponding to each of the antennas 2 of the antenna group #m.

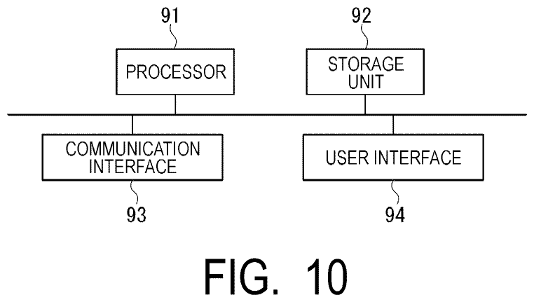

FIG. 10 is a diagram illustrating a hardware

configuration example of the ROF master unit 4. The ROF master unit 4 includes a processor 91, a storage unit 92, a communication interface 93, and a user interface 94. The processor 91 is a central processing apparatus that performs calculation and control. The processor 91 is, for example, a central processing unit (CPU). The processor 91 reads and executes the program from the storage unit 92. The storage unit 92 further includes a work area and the like to be used when the processor 91 executes various programs. The communication interface 93 is communicatively connected with another apparatus. The user interface 94 is an input device such as buttons, a keyboard, or a pointing device, and a display device such as lamps or a display. Artificial operations are inputted through the user interface 94.

All or some of the functions of the electrical switch control unit 46 are implemented by the processor 91 reading a program from the storage unit 92 and executing the program. All or some of the functions of the electrical switch control unit 46 may be realized by using hardware such as an application specific integrated circuit (ASIC), a programmable logic device (PLD), or a field programmable gate array (FPGA). Communication among the opto-electronic conversion unit 41, the electrical-optical conversion unit 44, the switch unit 45, the electrical switch control unit 46, and the wireless base station 5 is realized by the communication interface 93.

The hardware configuration of the wireless base station 5 is also the same as that in FIG. 10. All or some of the functions of the scheduler unit 54 are implemented by the processor 91 reading a program from the storage unit 92 and executing the program. All or some of the functions of the scheduler unit 54 may be attained by using hardware such as an ASIC, a PLD, or an FPGA. Communication between the transmission and reception unit 51 and the scheduler unit 54 and the RoF master unit 4 is implemented by the communication interface 93.

According to the embodiment described above, repeated use of wavelengths and suppression of deterioration of the signal-to-noise power ratio are possible.

According to the above-described embodiment, a wireless system includes a plurality of distributedly arranged antennas and a wireless base station. The plurality of antennas and the wireless base station are connected by using RoF. The plurality of antennas are divided into a plurality of groups. The wireless system switches in a time division manner for each group, and transmits or receives a radio wave by the antennas.

The wireless system may include a transmission unit. The transmission unit corresponds to, for example, the antenna 2, the opto-electronic conversion unit 41, and the electrical-optical conversion unit 44 of the embodiment.

The transmission unit transmits, between the antenna and the wireless base station, one or both of a signal having been received by the antenna by a radio wave and a signal to be transmitted from the antenna by a radio wave using an optical signal. The wireless base station performs one or both of processing of receiving a signal having been received by the antenna belonging to the group via a transmission unit and processing of transmitting a signal to be transmitted from the antenna belonging to the group by a radio wave to the antenna via the transmission unit at different timings for each group.

The optical wavelength of an optical signal used in one group is at least partially common to optical wavelengths of optical signals used in other groups.

The wireless system may include a switch unit. The switch unit performs one or both of processing of switching a signal having been output from the transmission unit to the wireless base station for each group and processing of switching a signal having been output from the wireless base station to the transmission unit for each group.

The wireless system may further include a switch control unit. The switch control unit controls switching processing in the switch unit based on a schedule of transmission or reception of radio waves in the wireless base station.

The antennas belonging to one group transmit and receive signals to and from the same terminal by radio waves.

According to the above-described embodiment, a wireless system includes distributedly arranged antennas, a wireless base station, and a transmission apparatus. The transmission apparatus corresponds to, for example, the ROF master unit 4 in the embodiment. The transmission apparatus includes a conversion unit and a switch unit. The conversion unit corresponds to, for example, the opto-electronic conversion unit 41 and the electrical-optical conversion unit 44 in the embodiment. The conversion unit is provided corresponding to each of the plurality of antennas. The conversion unit performs one or both of processing of converting an optical signal representing a signal having been received by the corresponding antenna by a radio wave into an electrical signal and processing of converting a signal to be transmitted from the corresponding antenna by a radio wave from an electrical signal into an optical signal. The plurality of antennas are divided into a plurality of groups. The switch unit performs one or both of processing of outputting, to the wireless base station, the electrical signal having been converted by the conversion unit corresponding to the antenna belonging to the group at different timings for each group, and processing of receiving the signal having been transmitted from the antenna from the wireless base station and outputting the received signal to the conversion unit corresponding to the antenna belonging to the group.

Although the embodiments of the present invention have been described in detail with reference to the drawings so far, specific configurations are not limited to these embodiments, and include designs, and the like, without departing from the gist of the invention.

### REFERENCE SIGNS LIST

1 Wireless system
2, 2-1-1 to 2-1-3, 2-2-1 to 2-2-3 Antenna
3, 3-1-1 to 3-1-3, 3-2-1 to 3-2-3 RoF slave unit
4 RoF master unit
5 Wireless base station
6 Optical fiber
7 Wireless terminal
41-1-1 to 41-1-3, 41-2-1 to 41-2-3, 41-M-1 to 41-M-3 Opto-electronic conversion unit
42-1 to 42-3 Electrical switch
43-1 to 43-3 Electrical switch
44-1-1 to 44-1-3, 44-2-1 to 44-2-3, 44-M-1 to 44-M-3
Electro-optical conversion unit
45 Switch unit
46 Electrical switch control unit
51 Transmission and reception unit
52-1 to 52-3 Reception unit
53-1 to 53-3 Transmission unit
54 Scheduler unit

1. A wireless system which connects a plurality of distributedly arranged antennas and a wireless base station using radio-over-fiber (RoF), wherein
the plurality of antennas are divided into a plurality of groups, and
a radio wave is transmitted or received by each of the plurality of antennas at timings different from each other for each of the plurality of groups.

2. The wireless system according to claim 1, the wireless system comprising:
a transmitter that transmits, between each of the plurality of antennas and the wireless base station, one or both of a received signal having been received by a radio wave by each of the plurality of antennas and converted into an optical signal and a transmission signal to be transmitted by a radio wave from each of the plurality of antennas and converted into an optical signal, wherein
the wireless base station performs one or both of (i) processing of receiving the received signal having been received by each of the plurality of antennas belonging to a first one of the plurality of groups via the transmitter at the timing different for the first one of the plurality of groups and (ii) processing of transmitting the transmission signal to be transmitted from each of the plurality of antennas belonging to a second one of the plurality of groups to each of the plurality of antennas via the transmitter at timing different for the second one of the plurality of groups.

3. The wireless system according to claim 2, wherein
an optical wavelength of the optical signal used in one of the plurality of groups is partially common to an optical wavelength of the optical signal used in another one of the plurality of groups.

4. The wireless system according to claim 2, the wireless system further comprising:
a switch unit that performs one or both of (i) processing of switching the received signal to be output from the transmitter to the wireless base station for each of the plurality of groups and (ii) processing of switching the transmission signal to be output from the wireless base station to the transmitter for each of the plurality of groups.

5. The wireless system according to claim 4, the wireless system further comprising:
a switch controller that controls the switch based on a schedule of transmission or reception of radio waves in the wireless base station.

6. The wireless system according to claim 1, wherein
the plurality of antennas belonging to one of the plurality of groups transmit the transmission signal and receive the received signal to and from a same terminal by a the radio wave.

7. A transmission apparatus comprising:
a plurality of converters, which are corresponding to the a plurality of distributedly arranged antennas, respectively, each performing one or both of (i) processing of converting an optical signal representing a received signal having been received by a corresponding antenna which is one of the plurality of the antennas by a radio wave into an electrical signal and (ii) processing of converting a an electrical signal to be transmitted from the corresponding antenna by a radio wave into an optical signal, the plurality of antennas being divided into a plurality of groups; and
a switch performing one or both of (i) processing of outputting, to a wireless base station, the electrical signal having been converted by the each of the plurality of converters corresponding to each of the plurality of antennas belonging to a first one of the plurality of groups at timings different from each other for each of the plurality of groups, and (ii) processing of receiving, from the wireless base station, the electrical signal to be transmitted from each of the plurality of antennas and outputting the received signal to each of the plurality of converters corresponding to each of the plurality of antennas belonging to a second one of the plurality of groups.

8. A transmission method executed by a wireless system in which a plurality of distributedly arranged antennas and a wireless base station are connected using radio-over-fiber (RoF), wherein
the plurality of antennas are divided into a plurality of groups, the method comprising:
transmitting and receiving, by the wireless system, a radio wave by each of the plurality of antennas at timings different from each other for each of the groups.
